(19) United States
(12) Patent Application Publication
(10) Pub. No.: US 2023/0101872 A1
(43) Pub. Date: Mar. 30, 2023

(54) VEHICLE AND CONTROL METHOD THEREOF

(71) Applicants: HYUNDAI MOTOR COMPANY, Seoul (KR); KIA CORPORATION, Seoul (KR)

(72) Inventors: Yongseok KWON, Gyeonggi-do (KR); Dong Hyun SUNG, Gyeonggi-do (KR); Junghyun KIM, Seoul (KR); Tae-Geun AN, Gyeongsangbuk-do (KR); Eungseo KIM, Gyeonggi-do (KR); Sangmin LEE, Seoul (KR)

(73) Assignees: Hyundai Motor Company, Seoul (KR); KIA CORPORATION, Seoul (KR)

(21) Appl. No.: 17/880,049

(22) Filed: Aug. 3, 2022

(30) Foreign Application Priority Data
Sep. 28, 2021 (KR) 10-2021-0128168

(51) Int. Cl. B60W 30/095

(52) U.S. Cl. CPC B60W 30/095; B60W 2420/52; B60W 2530/201; B60W 2554/40

(57) ABSTRACT

A vehicle includes a radar mounted to have a front field of view and a lateral field of view of the vehicle and configured to detect an object and acquire object data; a sensor configured to detect a movement of the vehicle and acquire motion data based on the movement of the vehicle; and a controller comprising a processor configured to process the object data and the motion data.

### CROSS-REFERENCE TO RELATED APPLICATION

This application is based on and claims priority under 35 U.S.C. § 119 to Korean Patent Application No. 10-2021-0128168, filed on Sep. 28, 2021 in the

Korean Intellectual Property Office, the disclosure of which is incorporated herein by reference.

### TECHNICAL FIELD

The disclosure relates to a vehicle and a control method thereof, and more specifically, to a driver assistance system.

### BACKGROUND

An advanced driver assistance system (ADAS) may determine the likelihood of collision with another vehicle or a pedestrian using various sensors such as a camera and a radar mounted on a vehicle, and automatically control a braking device or a steering device based on the determined collision likelihood to prevent an accident.

In particular, a forward collision-avoidance assist (FCA) among the ADAS may provide a driver with a warning and forcibly control a braking or steering operation of a vehicle to prevent a collision with an obstacle in front while driving.

Since a driver assistance system determines a risk of collision based on a current location of another vehicle, when the other vehicle in a next lane suddenly cuts in, the determination may not be immediately performed, or when moving to the next lane from the same lane, a more sensitive control is required.

### SUMMARY

An aspect of the disclosure provides a vehicle and a control method thereof that may prevent a sudden collision by additionally considering a relative lateral position and a relative longitudinal position of an object predicted in the event of a collision with the object.

Additional aspects of the disclosure will be set forth in part in the description which follows and, in part, will be obvious from the description, or may be learned by practice of the disclosure.

According to an embodiment of the disclosure, there is provided a vehicle performing an avoidance control, the vehicle including: a radar mounted on the vehicle to have a front field of view and a lateral field of view of the vehicle, and configured to detect an object and acquire object data; a sensor configured to detect a movement of the vehicle and acquire motion data based on the movement of the vehicle; and a controller including a processor configured to process the object data and the motion data, wherein the controller is configured to: acquire data of the object by processing the object data, calculate an overlap index which is a portion where a full width of the vehicle and the object overlap, based on the data, calculate a lateral offset which is a lateral distance between a center of a front of the vehicle and a center of the object, based on a maximum value and a minimum value of the data, and calculate an overlap where the lateral offset is reflected in the overlap index to reflect the overlap in the avoidance control.

The controller is configured to determine that a likelihood of collision with the object does not exist, when the overlap index corresponds to 0.

The controller is configured to continuously acquire the data based on a predicted path of the object according to the movement of the object.

The data includes first corner data about a front left corner of the object, second corner data about a rear left corner of the object, third corner data about a rear right corner of the object, and fourth corner data about a front right corner of the object.

The controller is configured to calculate an average of the maximum value of the data and the minimum value of the data based on a coordinate system of the vehicle to calculate the lateral offset.

The controller is configured to change a reference of the coordinate system of the vehicle based on a predicted path of the vehicle and calculate the overlap based on the changed coordinate system to reflect the overlap in the avoidance control.

The controller is configured to perfom the avoidance control to at a later time than an existing avoidance control time, when the vehicle is predicted to collide with a rear of the object.

The controller is configured to determine that the vehicle is likely to collide with the rear of the object based on a sign of the overlap and a movement direction of the object.

The controller is configured to perform the avoidance control at an earlier time than an existing avoidance control time, when the vehicle is predicted to collide with a front of the object.

The controller is configured to determine that the vehicle is likely to collide with the front of the object based on a sign of the overlap and a movement direction of the object.

According to an embodiment of the disclosure, there is provided a control method of a vehicle performing an avoidance control, the control method including: detecting an object, acquiring object data, and acquiring data by processing the object data; calculating an overlap index which is a portion where a full width of the vehicle and the object overlap, based on the data; calculating a lateral offset which is a lateral distance between a center of a front of the vehicle and a center of the object, based on a maximum value and a minimum value of the data; calculating an overlap where the lateral offset is reflected in the overlap index; and performing the avoidance control based on the calculated overlap.

The performing the avoidance control comprises determining that a likelihood of collision with the object does not exist, when the overlap index corresponds to 0.

The acquiring of the data includes continuously acquiring the data based on a predicted path of the object according to a movement of the object.

The acquiring of the data includes acquiring first corner data about a front left corner of the object, second corner data about a rear left corner of the object, third corner data about a rear right corner of the object, and fourth corner data about a front right corner of the object.

The calculating of the lateral offset includes calculating an average of the maximum value of the data and the minimum value of the data based on a coordinate system of the vehicle to calculate the lateral offset.

The performing the avoidance control includes changing a reference of the coordinate system of the vehicle based on a predicted path of the vehicle, and calculating the overlap based on the changed coordinate system to reflect the overlap in the avoidance control.

The avoidance control is performed at a later time than an existing avoidance control time, when the vehicle is predicted to collide with a rear of the object.

The performing the avoidance control includes determining that the vehicle is likely to collide with the rear of the object based on a sign of the overlap and a movement direction of the object.

The avoidance control is performed at an earlier time than an existing avoidance control time, when the vehicle is predicted to collide with a front of the object.

According to an embodiment of the disclosure, there is provided a non-transitory computer-readable recording medium storing a program for implementing a control method of a vehicle, when the program is executed by a processor, causing the processor to perform: acquiring data by processing object data; calculating an overlap index which is a portion where a full width of the vehicle and an object overlap, based on the data; calculating a lateral offset which is a lateral distance between a center of a front of the vehicle and a center of the object, based on a maximum value and a minimum value of the data; calculating an overlap where the lateral offset is reflected in the overlap index; and controlling the vehicle based on the avoidance control in which the overlap is reflected.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a configuration of a vehicle according to an embodiment;

FIG. 2 is a control block diagram illustrating a vehicle according to an embodiment;

FIG. 3 illustrates a camera and a radar included in a driver assistance system according to an embodiment;

FIG. 4 is a diagram for describing corner data according to an embodiment;

FIG. 5 is a flowchart illustrating a control method of a vehicle according to an embodiment;

FIGS. 6 to 12 are diagrams for describing an overlap index according to an embodiment;

FIG. 13 is a diagram for describing an overlap according to an embodiment; and

FIGS. 14 to 17 are diagrams illustrating examples to which embodiments of the disclosure are applied.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted. The terms such as “˜part”, “˜member”, “˜module”, “˜block”, and the like may refer to at least one process processed by at least one hardware or software. According to embodiments, a plurality of “˜part”, “˜member”, “˜module”, “˜block” may be embodied as a single element, or a single of “˜part”, “˜member”, “˜module”, “˜block” may include a plurality of elements.

It will be understood that when an element is referred to as being “connected” to another element, it can be directly or indirectly connected to the other element, wherein the indirect connection includes “connection” via a wireless communication network.

It will be understood that the terms “include” when used in this specification, specify the presence of stated features, integers, steps, operations, elements, and/or components, but do not preclude the presence or addition of one or more other features, integers, steps, operations, elements, components, and/or groups thereof.

It will be understood that when it is stated in this specification that a member is located “on” another member, not only a member may be in contact with another member, but also still another member may be present between the two members.

It will be understood that, although the terms first, second, etc. may be used herein to describe various elements, these elements should not be limited by these terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

Hereinafter, an operation principle and embodiments will be described in detail with reference to the accompanying drawings.

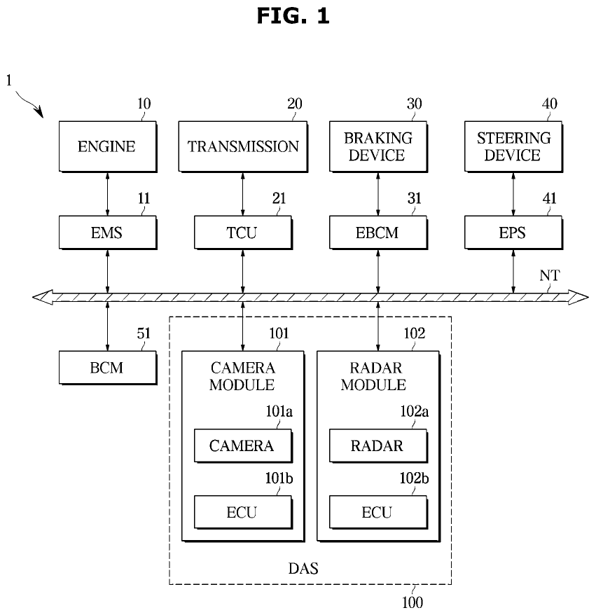

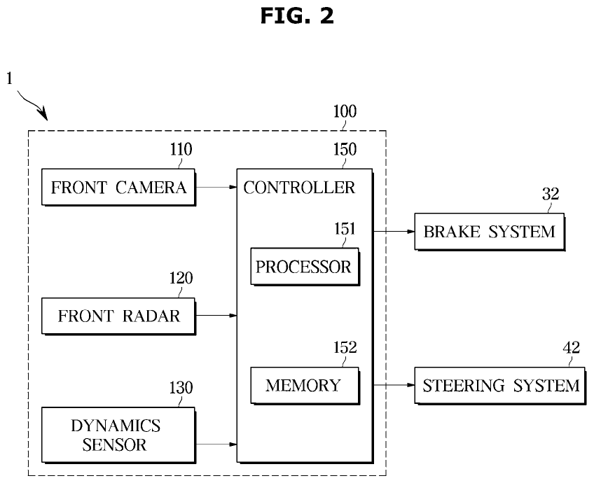

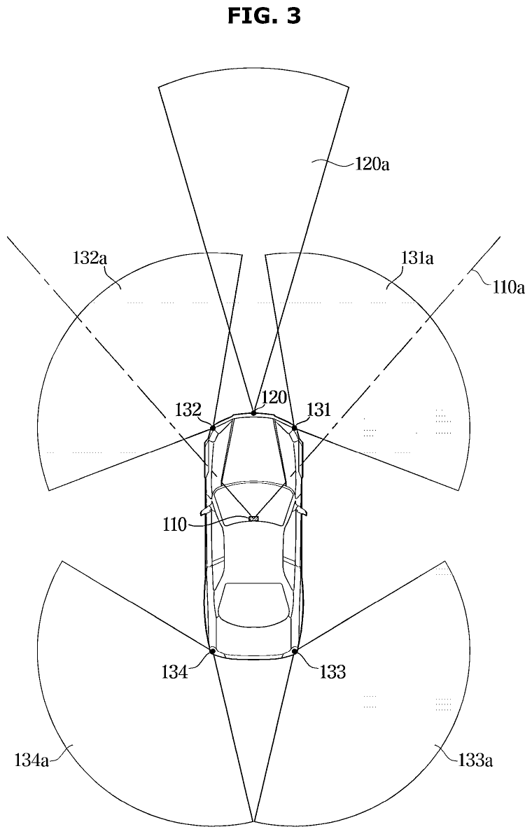

FIG. 1 illustrates a configuration of a vehicle according to an embodiment. FIG. 2 is a control block diagram illustrating a vehicle according to an embodiment. FIG. 3 illustrates a camera and a radar included in a driver assistance system according to an embodiment.

As shown in FIG. 1, a vehicle 1 includes an engine 10, a transmission 20, a braking device 30, and a steering device 40. The engine 10 includes a cylinder and a piston, and may generate power for driving the vehicle 1. The transmission 20 includes a plurality of gears and may transmit the power generated by the engine 10 to vehicle wheels. The braking device 30 may decelerate or stop the vehicle 1 through friction with the vehicle wheels. The steering device 40 may change a driving direction of the vehicle 1.

The vehicle 1 may include a plurality of electronic components. For example, the vehicle 1 may further include an engine management system (EMS) 11, a transmission control unit (TCU) 21, an electronic brake control module (EBCM) 31, an electronic power steering (EPS) 41, a body control module (BCM) 51, and a driver assistance system (DAS) 100.

The EMS 11 may control the engine 10 in response to a driver's acceleration intention through an accelerator pedal or a request from the DAS 100. For instance, the EMS 11 may control a torque of the engine 10.

The TCU 21 may control the transmission 20 in response to a driver's shift command through a shift lever and/or a driving speed of the vehicle 1. For example, the TCU 21 may adjust a shift ratio from the engine 10 to the vehicle wheels.

The EBCM 31 may control the braking device 30 in response to a driver's braking intention through a brake pedal and/or wheel slip. For example, the EBCM 31 may temporarily release the wheel braking in response to the wheel slip detected when braking the vehicle 1 (anti-lock braking system, ABS). The EBCM 31 may selectively release the wheel braking in response to oversteering and/or understeering detected when steering the vehicle 1 (electronic stability control, ESC). Also, the EBCM 31 may temporarily brake the wheels in response to the wheel slip detected when driving the vehicle 1 (traction control system, TCS).

The EPS 41 may assist operations of the steering device 40 so that a driver may easily manipulate a steering wheel according to a driver's steering intention. For instance, the EPS 41 may assist the operations of the steering device 40 to decrease a steering force when driving at a low speed or when parking, and increase a steering force when driving at a high speed.

The BCM 51 may control operations of electronic components that provide convenience to the driver or secure the driver safety. For example, the BCM 51 may control a head lamp, a wiper, a cluster, a multifunction switch, a turn signal, and the like.

The DAS 100 may assist the driver's operation (driving, braking, and steering). For instance, the DAS 100 may detect an environment (e.g., other vehicles, pedestrians, cyclists, lanes, road signs, etc.) around the vehicle 1, and control driving and/or braking and/or steering of the vehicle 1 in response to the detected environment.

The DAS 100 may provide the driver with a variety of functions. For example, the DAS 100 may provide functions such as a forward collision-avoidance assist (FCA), a lane departure warning (LDW), a lane keeping assist (LKA), a high beam assist (HBA), an autonomous emergency braking (AEB), a traffic sign recognition (TSR), a smart cruise control (SCC), a blind spot detection (BSD), and the like.

The DAS 100 may include a camera module 101 that acquires object data and image data around the vehicle 1 and a radar module 102 that acquires object data around the vehicle 1. The camera module 101 includes a camera 101a and an electronic control unit (ECU) 101b, and may photograph a front of the vehicle 1 and recognize other vehicles, pedestrians, cyclists, lanes, road signs, etc. The radar module 102 includes a radar 102a and an ECU 102b, and may acquire a relative location, a relative speed, etc., of the objects (e.g., other vehicles, pedestrians, cyclists, etc.) around the vehicle 1.

The DAS 100 is not limited to that illustrated in FIG. 1, and may further include a light detection and ranging (lidar) that detects an object around the vehicle 1 by scanning around the vehicle 1.

The above-described electronic components may communicate with each other via a vehicle communication network (NT). For example, the electronic components may transmit/receive data through Ethernet, media oriented systems transport (MOST), FlexRay, controller area network (CAN), local interconnect network (LIN), and the like. For instance, the DAS 100 may transmit a driving control signal, a braking signal, and a steering signal to the EMS 11, the EBCM 31, and the EPS 41, respectively, through a vehicle communication network (NT).

As shown in FIG. 2, the vehicle 1 may include a brake system 32, a steering system 42 and the DAS 100.

As described above, the vehicle 1 may perform an avoidance control based on a location and a relative speed of an object according to the DAS 100 performing a forward collision-avoidance assist (FCA). Here, the object refers to anything that the vehicle 1 in motion is required to avoid, such as other vehicles, pedestrians, cyclists, and the like.

The brake system 32 may include the EBCM 31 (refer to FIG. 1) and the braking device 30 (refer to FIG. 1), and the steering system 42 may include the EPS 41 (refer to FIG. 1) and the steering device 40 (refer to FIG. 1).

The DAS 100 may include a front camera 110, a front radar 120, and a plurality of corner radars. The front camera 110, the front radar 120 and the plurality of corner radars (not shown) are sensors for detecting an object located outside the vehicle 1, and may be collectively referred to as a sensing unit or a sensing module (not shown).

The sensing unit may detect the object, acquire object data and provide the object data to a controller 140. In this instance, the object data may include image data acquired from the front camera 110 and radar data acquired from the front radar 120 and/or the corner radars.

As shown in FIG. 3, the front camera 110 may have a field of view 110a facing a front of the vehicle 1. For example, the front camera 110 may be installed on a front windshield of the vehicle 1.

The front camera 110 may photograph the front of the vehicle 1 and acquire image data about the front of the vehicle 1. The image data about the front of the vehicle 1 may include locations of other vehicles, pedestrians, cyclists, or lanes located in front of the vehicle 1.

The front camera 110 may include a plurality of lens and image sensors. The image sensors may include a plurality of photodiodes converting light into an electrical signal, and the plurality of photodiodes may be arranged in a two-dimensional (2D) matrix.

The front camera 110 may be electrically connected to the controller 140. For instance, the camera 110 may be connected to the controller 140 via a vehicle communication network (NT), a hard wire, or a printed circuit board (PCB).

The front camera 110 may transmit the image data of the front of the vehicle 1 to the controller 140.

As shown in FIG. 3, the front radar 120 may have a field of sensing 120a facing the front of the vehicle 1. For example, the front radar 120 may be installed in a grille or a bumper of the vehicle 1.

The front radar 120 may include a transmission antenna (or a transmission antenna array) that transmits a transmission wave toward the front of the vehicle 1, and a receiving antenna (or a receiving antenna array) that receives a reflected wave reflected from an object. The front radar 120 may acquire front radar data from the transmission wave transmitted by the transmission antenna and the reflected wave received by the receiving antenna. The front radar data may include distance information and speed information about other vehicles, pedestrians or cyclists located in front of the vehicle 1. The front radar 120 may calculate a relative distance to an object based on a phase difference (or a time difference) between the transmission wave and the reflected wave, and calculate a relative speed of the object based on a frequency difference between the transmission wave and the reflected wave.

For instance, the front radar 120 may be connected to the controller 140 via a vehicle communication network (NT), a hard wire, or a PCB. The front radar 120 may transmit the front radar data to the controller 140.

A dynamics sensor 130 detects a movement of the vehicle 1, and acquires motion data based on the movement of the vehicle 1. The motion data includes information about a driving speed, a steering angle, and a yaw rate of the vehicle 1. The dynamics sensor 130 may be a known sensor such as a wheel speed sensor, a steering angle sensor, a yaw rate sensor, and the like. Also, the dynamics sensor 130 may be disposed at a wheel, a steering wheel, etc., of the vehicle 1 to detect the driving speed, the steering angle, the yaw rate, etc., of the vehicle 1 and transmit to the controller 140.

The plurality of corner radars include a first corner radar 131 mounted on a front right side of the vehicle 1, a second corner radar 132 mounted on a front left side of the vehicle 1, a third corner radar 133 mounted on a rear right side of the vehicle 1 and a fourth corner radar 134 mounted on a rear left side of the vehicle 1.

As shown in FIG. 3, the first corner radar 131 may have a field of sensing 131a facing the front right side of the vehicle 1. For example, the front radar 120 may be installed on a right side of a front bumper of the vehicle 1. The second corner radar 132 may have a field of sensing 132a facing the front left side of the vehicle 1, and be installed on a left side of the front bumper of the vehicle 1. The third corner radar 133 may have a field of sensing 133a facing the rear right side of the vehicle 1, and be installed on a right side of a rear bumper of the vehicle 1. The fourth corner radar 134 may have a field of sensing 134a facing the rear left side of the vehicle 1, and be installed on a left side of the rear bumper of the vehicle 1.

Each of the first to fourth corner radars 131, 132, 133 and 134 may include a transmission antenna and a receiving antenna. The first to fourth corner radars 131, 132, 133 and 134 may acquire first corner radar data, second corner radar data, third corner radar data and fourth corner radar data, respectively. The first corner radar data may include distance information and speed information about other vehicles, pedestrians or cyclists (hereinafter, referred to as “object”) located in the front right side of the vehicle 1. The second corner radar data may include distance information and speed information about an object located in the front left side of the vehicle 1. The third corner radar data and the fourth corner radar data may include distance information and relative speed of an object located in the rear right and rear left sides of the vehicle 1, respectively.

For instance, each of the first to fourth corner radars 131, 132, 133 and 134 may be connected to the controller 140 via a vehicle communication network (NT), a hard wire, or a PCB. The first to fourth corner radars 131, 132, 133 and 134 may transmit the first to fourth corner radar data to the controller 140, respectively.

The controller 140 may include the ECU 101b (refer to FIG. 1) of the camera module 101 (refer to FIG. 1), and/or the ECU 102b (refer to FIG. 1) of the radar module 102 (refer to FIG. 1), and/or a separate integrated controller.

The controller 140 may include a processor 141 and a memory 142.

The processor 141 may process front image data of the front camera 110, the front radar data of the front radar 120 and the corner radar data of the plurality of corner radars, and generate a steering signal and a braking signal for controlling the steering system 42 and the brake system 32, respectively. For example, the processor 141 may include an image processor for processing the front image data of the front camera 110, and/or a digital signal processor for processing the front radar data of the front radar 120, and/or a micro control unit (MCU) (or a microprocessor) for generating the steering signal and the braking signal.

The processor 141 may detect objects (e.g., other vehicles, pedestrians, cyclists, etc.) in front of the vehicle 1 based on the front image data of the front camera 110 and the front radar data of the front radar 120.

Specifically, the processor 141 may acquire locations (distance and direction) and relative speeds of the objects in front of the vehicle 1 based on the front radar data of the front radar 120. Also, the processor 141 may acquire locations (direction) and type information (for example, whether the object in front is another vehicle, a pedestrian, or a cyclist) of the objects in front of the vehicle 1 based on the front image data of the front camera 110. In addition, the processor 141 may match the objects detected by the front image data with the objects detected by the front radar data, and acquire the type information, locations and relative speeds of the objects in front of the vehicle 1 based on the matching result.

The processor 141 may generate the steering signal and the braking signal based on the type information, locations and relative speeds of the objects in front of the vehicle 1.

For example, the processor 141 may calculate a time to collision (TTC) between the vehicle 1 and the object in front based on the locations (distances) and relative speeds of the objects in front of the vehicle 1, and based on a comparison between the calculated TTC and a predetermined reference time, provide a warning to a driver, or transmit the braking signal to the brake system 32 or the steering signal to the steering system 42.

As another example, the processor 141 may calculate a distance to collision (DTC) based on the relative speeds of the objects in front, and based on a comparison between the calculated DTC and a distance to each of the objects in front, provide a warning to the driver, or transmit the braking signal to the brake system 32 or the steering signal to the steering system 42.

The processor 141 may acquire locations (distance and direction) and relative speeds of lateral objects (front right, front left, rear right and rear left sides) of the vehicle 1 based on the corner radar data of the plurality of corner radars.

The processor 141 may transmit the steering signal to the steering system 42 based on the locations (distance and direction) and relative speeds of the lateral objects of the vehicle 1.

For instance, when a collision with the object in front is predicted based on the TTC and the DTC, the processor 141 may transmit the steering signal to the steering system 42 to avoid the collision with the object in front.

The processor 141 may determine whether to avoid the collision with the object in front by changing a driving direction of the vehicle 1 based on the locations (distance and direction) and relative speeds of the lateral objects of the vehicle 1. For example, when the lateral object located on a side of the vehicle 1 does not exist, the processor 141 may transmit the steering signal to the steering system 42 to avoid the collision with the object in front. When a collision with the lateral object is not predicted after steering the vehicle 1 based on the locations (distance and direction) and the relative speeds of the lateral objects, the processor 141 may transmit the steering signal to the steering system 42 to avoid the collision with the object in front. When the collision with the lateral object is predicted after steering the vehicle 1 based on the locations (distance and direction) and the relative speeds of the lateral objects, the processor 141 may not transmit the steering signal to the steering system 42.

The memory 142 may store a program and/or data for the processor 141 to process the image data, a program and/or data for the processor 141 to process the radar data, and a program and/or data for processor 141 to generate the steering signal and/or the braking signal. The processor 141 may be configured to perform various operations when executing the program stored in the memory 142.

The memory 142 may temporarily store the image data received from the front camera 110 and/or the radar data received from the radars 120. Also, the memory 142 may temporarily store a processing result of the image data and/or the radar data by the processor 141.

The memory 142 may include a volatile memory such as a static random access memory (S-RAM) and dynamic random access memory (D-RAM), and a non-volatile memory such as a flash memory, a read only memory (ROM), an erasable programmable read only memory (EPROM), and the like.

The DAS 100 is not limited to that illustrated in FIG. 2, and may further include a lidar for detecting objects by scanning around the vehicle 1.

As described above, the controller 140 may transmit the braking signal to the brake system 32 based on whether the collision with the object in front is predicted. When the lateral object does not exist or the collision with the lateral object is not predicted, the controller 140 may transmit the steering signal to the steering system 42 to avoid the collision with the object in front. When the collision with the lateral object is predicted after steering the vehicle 1, the controller 140 may not transmit the steering signal to the steering system 42.

Meanwhile, data processed by the controller 140 and a subject of acquiring the data are described, before describing embodiments of the disclosure.

The vehicle 1 includes a front image sensor, a front non-image sensor, a lateral non-image sensor, a rear image sensor, and a rear non-image sensor. The front image sensor has a front field of view of the vehicle 1 and acquires the front image data. The front non-image sensor has a front field of sensing of the vehicle 1, is selected from the group consisting of a radar sensor and a lidar sensor, and acquires front detection data. The lateral non-image sensor has a lateral field of sensing of the vehicle 1, is selected from the group consisting of the radar sensor and the lidar sensor, and acquires lateral detection data. The rear image sensor has a rear field of view of the vehicle 1 and acquires rear image data. The rear non-image sensor has a rear field of sensing of the vehicle 1, is selected from the group consisting of the radar sensor and the lidar sensor, and acquires rear detection data.

The front image sensor and the front non-image sensor may detect an object in front of the vehicle 1.

The lateral non-image sensor may detect a lateral object located on sides of the vehicle 1, a front lateral object located on front right and front left sides of the vehicle 1, and a rear lateral object located on rear right and rear left sides of the vehicle 1. The lateral non-image sensor may be mounted at a corner of the vehicle 1 to independently detect the lateral object, the front lateral object and the rear lateral object, and also may be mounted on the sides of the vehicle 1 to detect the lateral object, the front lateral object and the rear lateral object, together with the front image sensor, the front non-image sensor, the rear image sensor, and the rear non-image sensor.

The rear image sensor and the rear non-image sensor may detect a rear object located at a rear of the vehicle 1.

The disclosure may be performed based on on/off of a turn indicator lamp of the vehicle 1, when an adaptive cruise control (ACC) is activated. For instance, when the turn indicator lamp of the vehicle 1 is turned on, the controller 140 may determine that a driver intends to change lanes and execute a control algorithm to be described later. Also, when a left turn indicator lamp of the vehicle 1 is turned on, the controller 140 may predict that the driver attempts to change lanes to the left, and perform control based on activation of the non-image sensor located on the left side. By contrast, when a right turn indicator lamp of the vehicle 1 is turned on, the controller 140 may predict that the driver attempts to change lanes to the right, and perform control based on activation of the non-image sensor located on the right side.

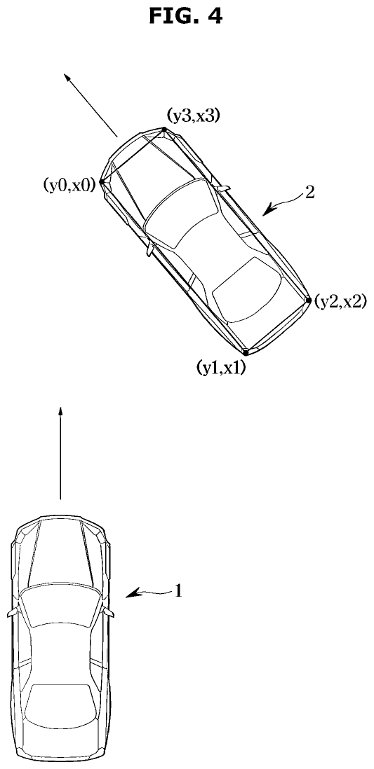

A configuration for implementing a control method of the vehicle 1 according to the disclosure and operations of each configuration have been described above. The disclosure may be performed when the controller 140 processes corner data of an object 2, and the corner data may be obtained through object data and/or image data, which is described in detail with reference to FIG. 4.

FIG. 4 is a diagram for describing corner data according to an embodiment.

Referring to FIG. 4, corner data includes first corner data (y0, x0) about a front left corner of the object 2, second corner data (y1, x1) about a rear left corner of the object 2, third corner data (y2, x2) about a rear right corner of the object 2, and fourth corner data (y3, x3) about a front right corner of the object 2. The corner data defines a lateral position and a longitudinal position based on a coordinate system based on the vehicle 1 and may have a variable value due to a relative movement of the vehicle 1 and the object 2.

According to an embodiment, the controller 140 may continuously acquire the corner data based on a predicted path according to a movement of the object 2. In this instance, the controller 140 may refer to motion data obtained from the dynamics sensor 130 to acquire the corner data based on the predicted path.

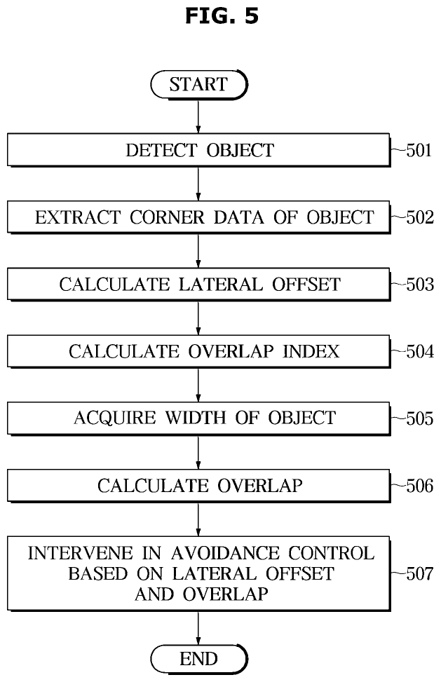

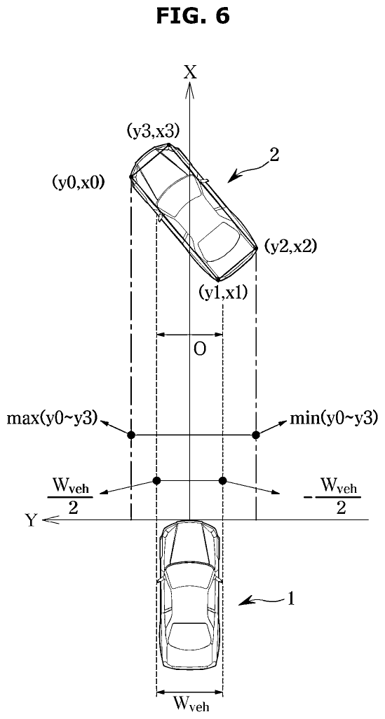

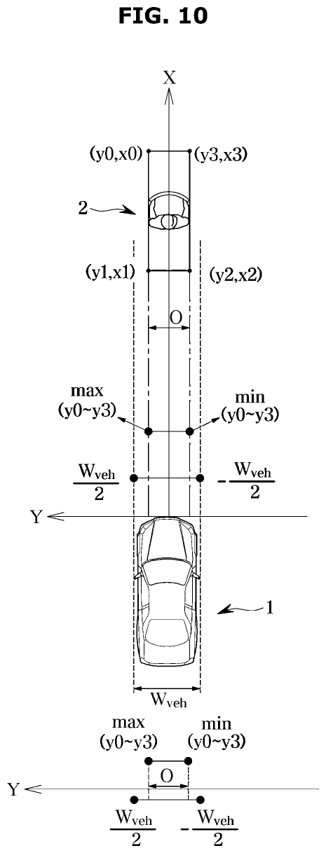

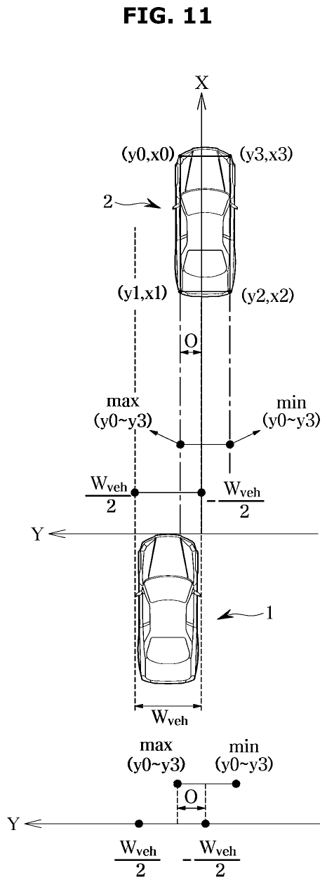

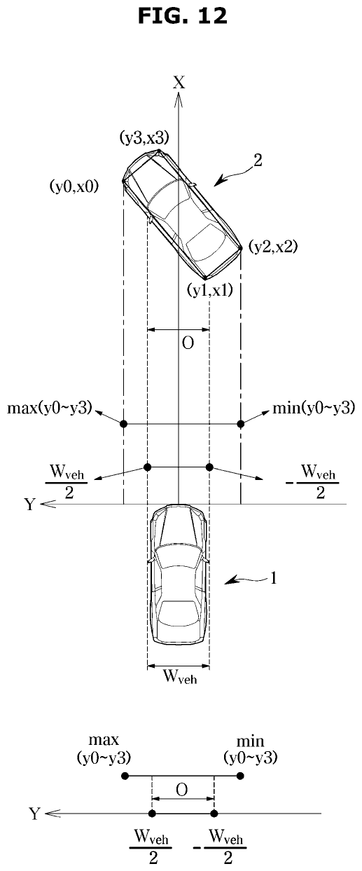

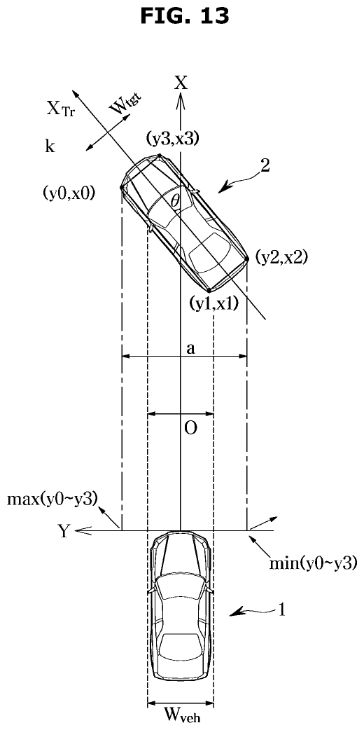

FIG. 5 is a flowchart illustrating a control method of a vehicle according to an embodiment. FIGS. 6 to 12 are diagrams for describing an overlap index according to an embodiment. FIG. 13 is a diagram for describing an overlap according to an embodiment.

The controller 140 detects an object through a sensing unit (501), and extracts corner data of the object (502). A detailed process of extracting the corner data has been described with reference to FIG. 4.

The controller 140 calculates a lateral offset and an overlap index using the corner data (503, 504). An order of calculating the lateral offset and the overlap index is not limited to that illustrated in FIG. 5, and the lateral offset and the overlap index may be simultaneously calculated or the overlap index may be calculated first according to settings.

Examples of calculating the overlap index are described with reference to FIGS. 6 to 12.

Referring to FIG. 6, an overlap index O corresponds to a width in which a portion of one side of the object 2 is projected onto the vehicle 1. That is, the overlap index O indicates a y-axis component of the object 2 that overlaps the vehicle 1.

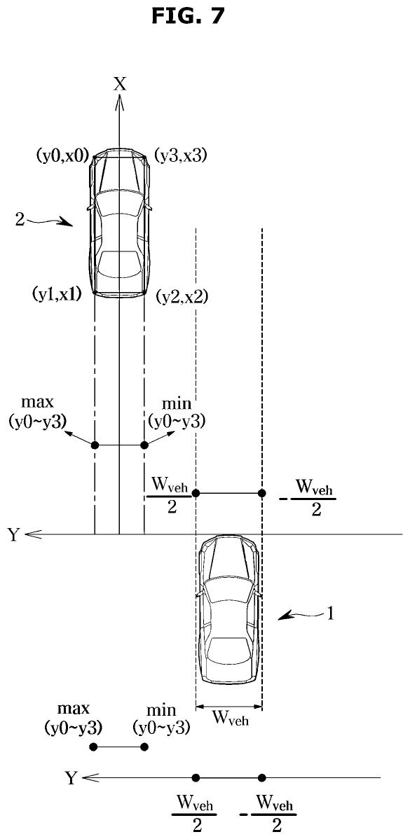

More specific examples are described with reference to FIGS. 7 to 12. The examples described in FIGS. 7 to 12 as well as FIG. 6 may be the overlap index O at current locations of the vehicle 1 and the object 2, or the overlap index O after a predetermined period of time based on a predicted path.

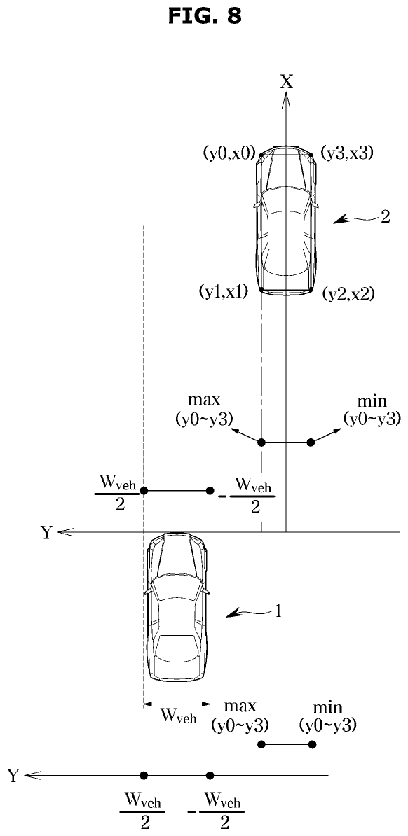

FIGS. 7 and 8 show examples where the overlap index O is 0, because a y-axis component where the vehicle 1 and the object 2 overlap is non-existent. In this instance, the overlap index O may be calculated based on a condition of Equation 1 below. When Equation 1 below is satisfied, the overlap index O is determined as 0.

$$min ( {y}_{0} ∼ {y}_{3} ) \geq \frac{{w}_{veh}}{2} or max ( {y}_{0} ∼ {y}_{3} ) \leq - \frac{{w}_{veh}}{2} \qquad [ Equation 1 ]$$

(Wᵥₑₕ: a full width of the vehicle)

According to an embodiment, the controller 140 may calculate the overlap index O based on the corner data, and when the overlap index O is 0, determine that the vehicle 1 is not likely to collide with the object 2. In this instance, the controller 140 maintains an existing avoidance control without delaying or advancing a collision avoidance time.

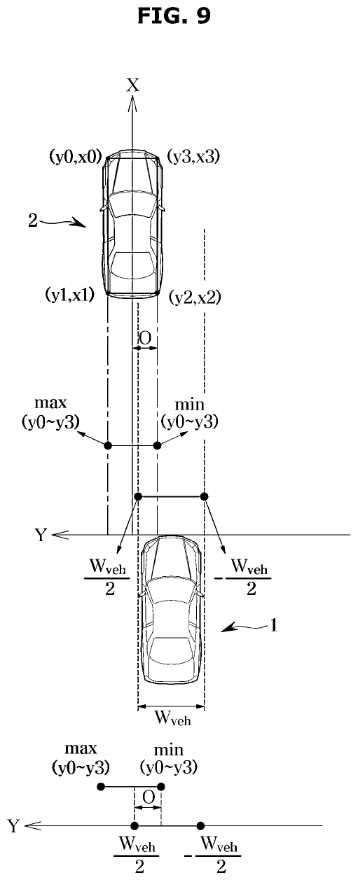

FIGS. 9 to 12 show examples where values of overlap index O exist, because the y-axis component where the vehicle 1 and the object 2 overlap exists. In this instance, when the overlap index O has a value other than 0, it is determined that the vehicle 1 is likely to collide with the object 2. In this instance, the overlap index O may be calculated based on a condition of Equation 2 below, and when Equation 2 below is satisfied, it is determined that the overlap index O is not 0.

$$min \{ max ( {y}_{0} ∼ {y}_{3} ) , \frac{{w}_{v e h}}{2} \} - max \{ min ( {y}_{0} ∼ {y}_{3} ) , - \frac{{w}_{v e h}}{2} \} \qquad [ Equation 2 ]$$

(Wᵥₑₕ: a full width of the vehicle)

According to an embodiment, the controller 140 may calculate the overlap index O based on the corner data, and when the overlap index O has a value other than 0, determine that the vehicle 1 is likely to collide with the object 2. In this instance, the controller 140 may perform the avoidance control at a delayed collision avoidance time or at a point in time earlier than an existing avoidance control time.

Referring again to FIG. 5, the controller 140 acquires a width of the object 2 (505). In this instance, the width of the object 2 corresponds to a full width of a front side of the object 2.

The controller 140 calculates an overlap based on the information calculated in operation 502 to operation 505 (506).

Meanwhile, referring to FIG. 13, an overlap Y may be calculated based on the overlap index O. A contact surface of the object 2 predicted to collide with the vehicle 1 may be predicted through the overlap Y, and the overlap Y corresponds to data that reflects a direction of the object 2, i.e., a heading angle ⊖ of the object 2.

First, the controller 140 calculates a lateral offset X in order to calculate the overlap Y. The lateral offset X corresponds to a lateral distance between a center of a front of the vehicle 1 and a center of the object 2, and may be calculated by,

$$X = \frac{max ( y 0 ∼ y 3 ) + min ( y 0 ∼ y 3 )}{2} \qquad [ Equation 3 ]$$

The controller 140 may calculate the lateral offset X by calculating an average of a maximum value of the corner data and a minimum value of the corner data based on a coordinate system of the vehicle 1.

Also, the overlap Y may be calculated by Equation 4 below, and the controller 140 may change a reference of the coordinate system of the vehicle 1 based on the predicted path of the vehicle 1, and calculate the overlap Y based on the changed coordinate system.

$$If {w}_{tgt} \geq {w}_{th} ,$$

$$Y = \frac{o}{{w}_{veh}} \times ( X sign ) \times 100$$

$$If ( {w}_{tgt} < {w}_{th} ) and ( abs ( X ) < \frac{{w}_{veh}}{2} ) ,$$

$$Y = \frac{a}{o} \times ( 1 - \frac{abs ( X )}{\frac{{w}_{veh}}{2}} ) \times ( X sign ) \times 100$$

in the other cases, Y=0

(Wt_{tgt}: full width of the object, wₜₕ: constant, wᵥₑₕ: full width of the vehicle,

a: a y-axis length of the object projected onto the vehicle)

When the overlap Y is calculated as shown above, the controller 140 intervenes in the avoidance control of the vehicle 1 based on the calculated overlap Y (507).

According to an embodiment, when the overlap Y is a positive number (+), the controller 140 determines that the vehicle 1 is likely to collide with a rear of the object 2. In this instance, the controller 140 may consider that the vehicle 1 is not likely to suddenly collide with the object 2, and delay the avoidance control to a second point in time later than an existing first point in time or maintain the existing avoidance control.

In addition, according to an embodiment, when the overlap Y is a negative number (−), the controller 140 determines that the vehicle 1 is likely to collide with a front of the object 2. In this instance, the controller 140 may predict that the vehicle 1 is likely to suddenly collide with the object 2, and control the vehicle 1 to perform the avoidance control at a third point in time earlier than the existing first point in time.

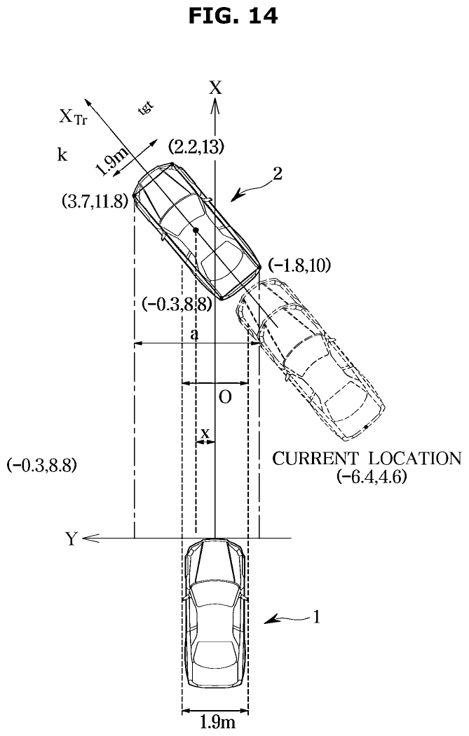

FIGS. 14 to 17 are diagrams illustrating examples to which embodiments of the disclosure are applied. Here, it is assumed that wₜₕ=1.9.

Referring to FIG. 14, the overlap index O is calculated as,

$$min \{ max ( {y}_{0} ∼ {y}_{3} ) , \frac{{w}_{v e h}}{2} \} - max \{ min ( {y}_{0} ∼ {y}_{3} ) , - \frac{{w}_{v e h}}{2} \} = min \{ 3.7 , 0.95 \} - max \{ - 1.8 , - 0.95 \} = 0.95 - \{ - 0.95 \} = 1.9$$

and the lateral offset X is calculated as,

$$\frac{max ( y 0 ∼ y 3 ) + min ( y 0 ∼ y 3 )}{2} = \frac{3.7 + ( - 1.8 )}{2} = 0.95$$

and also the overlap Y is calculated as,

$$\frac{o}{{w}_{veh}} \times ( sign of X ) \times 100 = \frac{1.9}{1.9} \times ( + 1 ) \times 100 = 100 \%$$

In this instance, because the overlap Y is a positive number and has a relatively large value, the vehicle 1 is highly likely to collide. In this instance, the controller 140 may control the vehicle 1 to perform the avoidance control at the third point in time earlier than the existing first point in time.

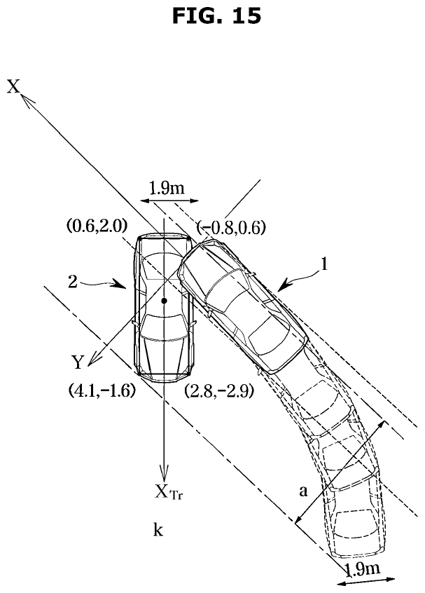

Referring to FIG. 15, the overlap index O is calculated as,

$$min \{ max ( {y}_{0} ∼ {y}_{3} ) , \frac{{w}_{v e h}}{2} \} - max \{ min ( {y}_{0} ∼ {y}_{3} ) , - \frac{{w}_{v e h}}{2} \} = min \{ 4.1 , 0.95 \} - max \{ - 0.8 , - 0.95 \} = 0.95 - \{ - 0.8 \} = 1.75$$

and the lateral offset X is calculated as,

$$\frac{max ( y 0 ∼ y 3 ) + min ( y 0 ∼ y 3 )}{2} = \frac{4.1 + ( - 0.8 )}{2} = 1.65$$

and also the overlap Y is calculated as,

$$\frac{o}{{w}_{veh}} \times ( sign of X ) \times 100 = \frac{1.75}{1.9} \times ( + 1 ) \times 100 = 92.1 \%$$

Even in this instance, the overlap Y is a positive number and has a relatively large value, and thus the vehicle 1 is highly likely to collide. In this instance, the controller 140 may control the vehicle 1 to perform the avoidance control at the third point in time earlier than the existing first point in time.

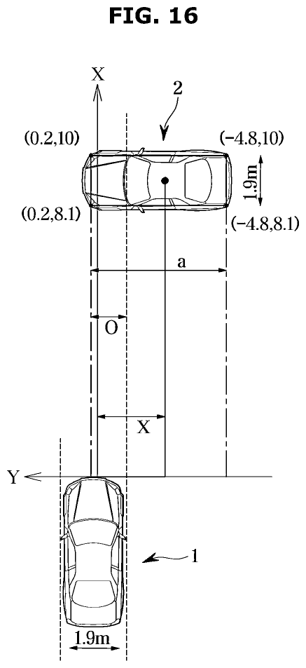

Referring to FIG. 16, the overlap index O is calculated as,

$$min \{ max ( {y}_{0} ∼ {y}_{3} ) , \frac{{w}_{v e h}}{2} \} - max \{ min ( {y}_{0} ∼ {y}_{3} ) , - \frac{{w}_{v e h}}{2} \} = min \{ 0.2 , 0.95 \} - max \{ - 4.8 , - 0.95 \} = 0.2 - \{ - 0.95 \} = 1.15$$

and the lateral offset X is calculated as,

$$\frac{max ( y 0 ∼ y 3 ) + min ( y 0 ∼ y 3 )}{2} = \frac{0.2 + ( - 4.8 )}{2} = - 2.3$$

and also the overlap Y is calculated as,

$$\frac{o}{{w}_{veh}} \times ( sign of X ) \times 100 = \frac{1.15}{1.9} \times ( - 1 ) \times 100 = 60.5 \%$$

Unlike the embodiments of FIGS. 14 and 15, in an embodiment of FIG. 16, a sign of the overlap Y is negative (−), and thus the vehicle 1 is likely to collide with the front of the object 2. However, because the overlap Y has a relatively small value in FIG. 16, the avoidance control may be performed at a point in time later than the third point in time compared to FIGS. 14 and 15.

As an example, when a collision between the vehicle 1 and the front of the object 2 is predicted when the object 2 moves from right to left, the sign of the overlap Y may be negative (−). In this instance, the vehicle 1 is likely to collide with the front of the object 2, and thus the avoidance control may be performed at the third point in time earlier than the first point in time.

By contrast, when the collision between the vehicle 1 and the front of the object 2 is predicted when the object 2 moves from left to right, the sign of the overlap Y may be positive (+). In this instance, the vehicle 1 is likely to collide with the front of the object 2, and thus the avoidance control may be performed at the third point in time earlier than the first point in time.

As another example, when a collision between the vehicle 1 and the rear of the object 2 is predicted when the object 2 moves from right to left, the sign of the overlap Y may be positive (+). In this instance, since the vehicle 1 is likely to collide with the rear of the object 2, the avoidance control may be performed at the second point in time later than the first point in time.

By contrast, when the collision between the vehicle 1 and the rear of the object 2 is predicted when the object 2 moves from left to right, the sign of the overlap Y may be negative (−). In this instance, since the vehicle 1 is likely to collide with the rear of the object 2, the avoidance control may be performed at the second point in time later than the first point in time.

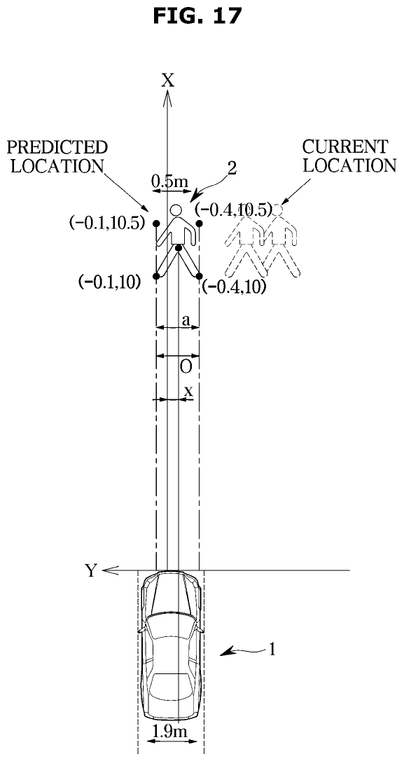

Referring to FIG. 17, the overlap index O is calculated as,

$$min \{ max ( {y}_{0} ∼ {y}_{3} ) , \frac{{w}_{v e h}}{2} \} - max \{ min ( {y}_{0} ∼ {y}_{3} ) , - \frac{{w}_{v e h}}{2} \} = min \{ 0.1 , 0.95 \} - max \{ - 0.4 , - 0.95 \} = 0.1 - \{ - 0.4 \} = 0.5$$

and the lateral offset X is calculated as,

$$\frac{max ( y 0 ∼ y 3 ) + min ( y 0 ∼ y 3 )}{2} = \frac{0.1 + ( - 0.4 )}{2} = - 0.15$$

and also the overlap Y is calculated as,

$$\frac{a}{o} \times ( 1 - \frac{abs ( X )}{\frac{{w}_{veh}}{2}} ) \times ( sign of X ) \times 100 = \frac{0.5}{0.5} \times ( 1 - \frac{abs ( - 0.15 )}{\frac{1.9}{2}} ) \times ( - 1 ) \times 100 = - 84.2 \%$$

In this instance, because the overlap Y has a relatively large value in the embodiment of FIG. 17 compared to the embodiment of FIG. 16, the avoidance control may be performed at a point in time earlier than the embodiment of FIG. 16.

As is apparent from the above, according to the embodiments of the disclosure, the vehicle and the control method thereof can predict a collision even when an object suddenly cuts in, and also accurately determine a movement tendency of the object using corner data of the object.

Embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include read only memory (ROM), random access memory (RAM), magnetic tapes, magnetic disks, flash memories, and optical recording medium.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A vehicle performing an avoidance control, the vehicle comprising:
a radar mounted on the vehicle to have a front field of view and a lateral field of view of the vehicle, and configured to detect an object and acquire object data;
a sensor configured to detect a movement of the vehicle and acquire motion data based on the movement of the vehicle; and
a controller comprising a processor configured to process the object data and the motion data,
wherein the controller is configured to:
acquire data of the object by processing the object data,
calculate an overlap index which is a portion where a full width of the vehicle and the object overlap, based on the data,
calculate a lateral offset which is a lateral distance between a center of a front of the vehicle and a center of the object, based on a maximum value and a minimum value of the data, and
calculate an overlap where the lateral offset is reflected in the overlap index to reflect the overlap in the avoidance control.

2. The vehicle of claim 1, wherein the controller is configured to determine that a likelihood of collision with the object does not exist, when the overlap index corresponds to 0.

3. The vehicle of claim 1, wherein the controller is configured to continuously acquire the data based on a predicted path of the object according to the movement of the object.

4. The vehicle of claim 1, wherein the data includes first corner data about a front left corner of the object, second corner data about a rear left corner of the object, third corner data about a rear right corner of the object, and fourth corner data about a front right corner of the object.

5. The vehicle of claim 1, wherein the controller is configured to calculate an average of the maximum value of the data and the minimum value of the data based on a coordinate system of the vehicle to calculate the lateral offset.

6. The vehicle of claim 5, wherein the controller is configured to change a reference of the coordinate system of the vehicle based on a predicted path of the vehicle and calculate the overlap based on the changed coordinate system to reflect the overlap in the avoidance control.

7. The vehicle of claim 1, wherein the controller is configured to perfom the avoidance control at a later time than an existing avoidance control time, when the vehicle is predicted to collide with a rear of the object.

8. The vehicle of claim 7, wherein the controller is configured to determine that the vehicle is likely to collide with the rear of the object based on a sign of the overlap and a movement direction of the object.

9. The vehicle of claim 1, wherein the controller is configured to perform the avoidance control at an earlier time than an existing avoidance control time, when the vehicle is predicted to collide with a front of the object.

10. The vehicle of claim 9, wherein the controller is configured to determine that the vehicle is likely to collide with the front of the object based on a sign of the overlap and a movement direction of the object.

11. A control method of a vehicle performing an avoidance control, the control method comprising:
detecting an object, acquiring object data, and acquiring data by processing the object data;
calculating an overlap index which is a portion where a full width of the vehicle and the object overlap, based on the data;
calculating a lateral offset which is a lateral distance between a center of a front of the vehicle and a center of the object, based on a maximum value and a minimum value of the data; calculating an overlap where the lateral offset is reflected in the overlap index; and
performing the avoidance control based on the calculated overlap.

12. The control method of claim 11, wherein the performing the avoidance control comprises determining that a likelihood of collision with the object does not exist, when the overlap index corresponds to 0.

13. The control method of claim 11, wherein the acquiring of the data comprises continuously acquiring the data based on a predicted path of the object according to a movement of the object.

14. The control method of claim 11, wherein the acquiring of the data comprises acquiring first corner data about a front left corner of the object, second corner data about a rear left corner of the object, third corner data about a rear right corner of the object, and fourth corner data about a front right corner of the object.

15. The control method of claim 11, wherein the calculating of the lateral offset comprises calculating an average of the maximum value of the data and the minimum value of the data based on a coordinate system of the vehicle to calculate the lateral offset.

16. The control method of claim 15, wherein the performing the avoidance control comprises changing a reference of the coordinate system of the vehicle based on a predicted path of the vehicle, and calculating the overlap based on the changed coordinate system to reflect the overlap in the avoidance control.

17. The control method of claim 11, wherein the avoidance control is performed at a later time than an existing avoidance control time, when the vehicle is predicted to collide with a rear of the object.

18. The control method of claim 17, wherein the performing the avoidance control comprises determining that the vehicle is likely to collide with the rear of the object based on a sign of the overlap and a movement direction of the object.

19. The control method of claim 11, wherein the avoidance control is performed at an earlier time than an existing avoidance control time, when the vehicle is predicted to collide with a front of the object.

20. A non-transitory computer-readable recording medium storing a program for implementing a control method of a vehicle, when the program is executed by a processor, causing the processor to perform:
acquiring data by processing object data;
calculating an overlap index which is a portion where a full width of the vehicle and an object overlap, based on the data;
calculating a lateral offset which is a lateral distance between a center of a front of the vehicle and a center of the object, based on a maximum value and a minimum value of the data;
calculating an overlap where the lateral offset is reflected in the overlap index; and
controlling the vehicle based on the avoidance control in which the overlap is reflected.
